(19) United States
(12) Patent Application Publication
(10) Pub. No.: US 2025/0338269 A1
(43) Pub. Date: Oct. 30, 2025

(54) FRAMEWORK FOR TDMA BASED MULTI-AP COORDINATION

(71) Applicant: Samsung Electronics Co., Ltd., Suwon-si (KR)

(72) Inventors: Rubayet Shafin, Frisco, TX (US); Boon Loong Ng, Plano, TX (US); Yue Qi, Plano, TX (US); Peshal Nayak, Plano, TX (US); Vishnu Vardhan Ratnam, Plano, TX (US); Bilal Sadiq, Plano, TX (US)

(21) Appl. No.: 19/178,721

(22) Filed: Apr. 14, 2025

Related U.S. Application Data
(60) Provisional application No. 63/635,304, filed on Apr. 17, 2024.
(60) Provisional application No. 63/754,991, filed on Feb. 6, 2025.

(51) Int. Cl. H04W 72/121; H04W 74/0808

(52) U.S. Cl. CPC H04W 72/121; H04W 74/0808

(57) ABSTRACT

A method and device for a framework for time division multiple access (TDMA) based multi-access point (MAP) coordination. A method of wireless communication performed by a first access point (AP) comprises transmitting, to a second AP, a message including coordination information for coordinating with the first AP on a basis of MAP. The method includes negotiating, with the second AP, a MAP coordination mechanism to be used for the MAP coordination; and forming a MAP coordination group based on the negotiated MAP coordination mechanism.

### CROSS-REFERENCE TO RELATED APPLICATION(S) AND CLAIM OF PRIORITY

This application claims priority under 35 U.S.C. § 119(e) to U.S. Provisional Patent Application No. 63/635,304, filed on Apr. 17, 2024, and U.S. Provisional Patent Application No. 63/754,991, filed on Feb. 6, 2025, which are hereby incorporated by reference in their entirety.

### TECHNICAL FIELD

This disclosure relates generally to wireless communication, and more specifically to a framework for time division multiple access (TDMA) based multi-access point (MAP) coordination.

### BACKGROUND

Wireless Local Area Network (WLAN) technology allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax, etc.

### SUMMARY

Embodiments of the present disclosure provide methods and apparatuses for a framework for TDMA MAP coordination.

In one embodiment, a method of wireless communication performed by a first access point (AP) comprises transmitting, to a second AP, a message including coordination information for coordinating with the first AP on a basis of MAP. The method includes negotiating, with the second AP, a MAP coordination mechanism to be used for the MAP coordination; and forming a MAP coordination group based on the negotiated MAP coordination mechanism.

In another embodiment, a first AP comprises a transceiver configured to transmit, to a second AP, a message including coordination information for coordinating with the first AP on a basis of multi-AP coordination (MAP). The first AP further comprises a processor operably coupled with the transceiver, the processor configured to: negotiate, with the second AP, a MAP coordination mechanism to be used for the MAP coordination; and form a MAP coordination group based on the negotiated MAP coordination mechanism.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit”, “receive”, and “communicate”, as well as derivatives thereof, encompass both direct and indirect communication. The terms “include” and “comprise,” as well as derivatives thereof, mean inclusion without limitation. The term “or” is inclusive, meaning and/or. The phrase “associated with”, as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example access point (AP) according to embodiments of the present disclosure;

FIG. 3 illustrates an example station (STA) according to embodiments of the present disclosure;

FIG. 4 illustrates an example of MAP coordination according to embodiments of the present disclosure;

FIG. 5 illustrates an example of an overall framework for coordinated TDMA (C-TDMA) according to embodiments of the present disclosure;

FIG. 6 illustrates an example of an architecture for MAP negotiation according to embodiments of the present disclosure;

FIG. 7 illustrates another example of an architecture for MAP negotiation according to embodiments of the present disclosure;

FIG. 8 illustrates an example of access point (AP) agreement ID assignment according to embodiments of the present disclosure;

FIG. 9 illustrates another example of AP agreement ID assignment according to embodiments of the present disclosure;

FIG. 10 illustrates yet another example of AP agreement ID assignment according to embodiments of the present disclosure; and

FIG. 11 illustrates an example method performed by an AP in a wireless communication system according to embodiments of the present disclosure.

### DETAILED DESCRIPTION

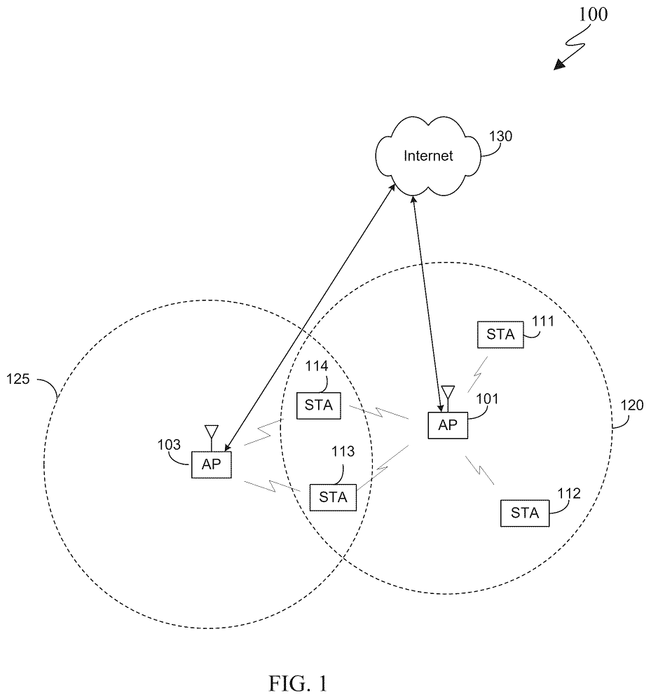

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WI-FI or other WLAN communication techniques. The STAs 111-114 may communicate with each other using peer-to-peer protocols, such as Tunneled Direct Link Setup (TDLS).

Depending on the network type, other well-known terms may be used instead of “access point” or “AP”, such as “router” or “gateway”. For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,”“remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the APs may include circuitry and/or programming for facilitating a framework for TDMA based MAP coordination. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

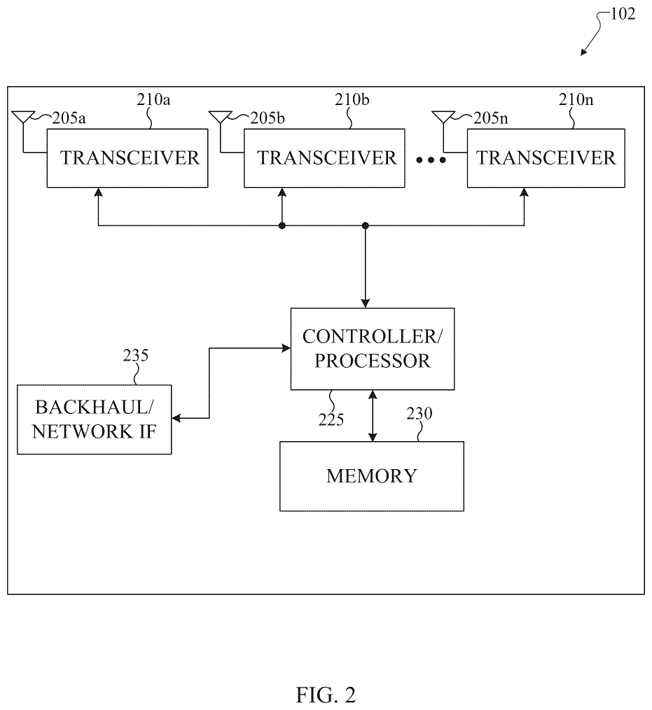

FIG. 2 illustrates an example AP 101 according to various embodiments of the present disclosure. The embodiment of the AP 101 illustrated in FIG. 2 is for illustration only, and the AP 103 of FIG. 1 could have the same or similar configuration. However, APs come in a wide variety of configurations, and FIG. 2 does not limit the scope of this disclosure to any particular implementation of an AP.

The AP 101 includes multiple antennas 204a-204n and multiple transceivers 209a-209n. The AP 101 also includes a controller/processor 224, a memory 229, and a backhaul or network interface 234. The transceivers 209a-209n receive, from the antennas 204a-204n, incoming radio frequency (RF) signals, such as signals transmitted by STAs 111-114 in the network 100. The transceivers 209a-209n down-convert the incoming RF signals to generate IF or baseband signals. The IF or baseband signals are processed by receive (RX) processing circuitry in the transceivers 209a-209n and/or controller/processor 224, which generates processed baseband signals by filtering, decoding, and/or digitizing the baseband or IF signals. The controller/processor 224 may further process the baseband signals.

Transmit (TX) processing circuitry in the transceivers 209a-209n and/or controller/processor 224 receives analog or digital data (such as voice data, web data, e-mail, or interactive video game data) from the controller/processor 224. The TX processing circuitry encodes, multiplexes, and/or digitizes the outgoing baseband data to generate processed baseband or IF signals. The transceivers 209a-209n up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the transceivers 209a-209n in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including facilitating a framework for TDMA based MAP coordination. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for facilitating a framework for TDMA based MAP coordination. Although FIG. 2 illustrates one example of AP 101, various changes may be made to FIG. 2. For example, the AP 101 could include any number of each component shown in FIG. 2. As a particular example, an access point could include a number of interfaces 234, and the controller/processor 224 could support routing functions to route data between different network addresses. Alternatively, only one antenna and transceiver path may be included, such as in legacy APs. Also, various components in FIG. 2 could be combined, further subdivided, or omitted and additional components could be added according to particular needs.

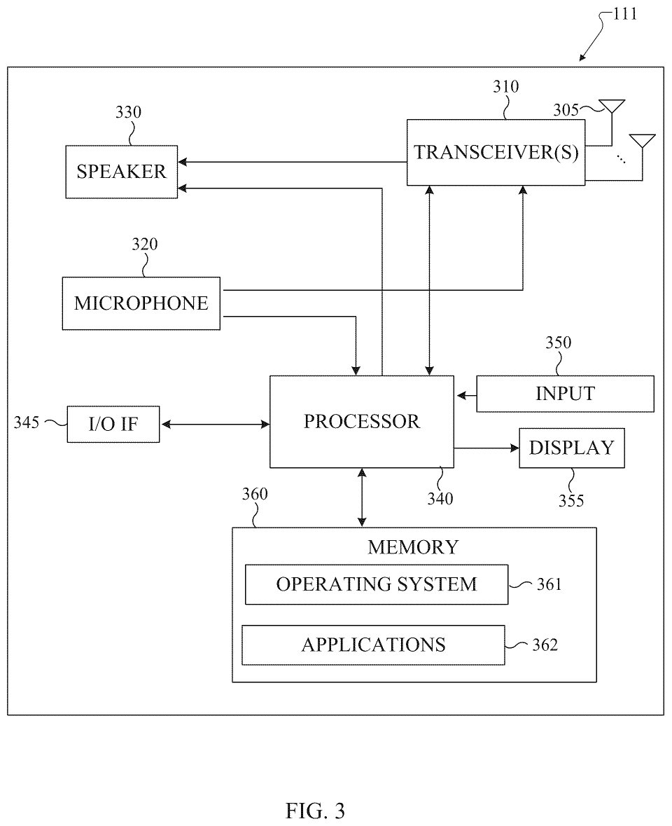

FIG. 3 illustrates an example STA 111 according to various embodiments of the present disclosure. The embodiment of the STA 111 illustrated in FIG. 3 is for illustration only, and the STAs 111-115 of FIG. 1 could have the same or similar configuration. However, STAs come in a wide variety of configurations, and FIG. 3 does not limit the scope of this disclosure to any particular implementation of a STA.

The STA 111 includes antenna(s) 305, transceiver(s) 310, a microphone 320, a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna(s) 305, an incoming RF signal (e.g., transmitted by an AP 101 of the network 100). The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors and execute the basic OS program 361 stored in the memory 360 in order to control the overall operation of the STA 111. In one such operation, the processor 340 controls the reception of forward channel signals and the transmission of reverse channel signals by the transceiver(s) 310 in accordance with well-known principles. The processor 340 can also include processing circuitry configured to facilitate a framework for TDMA based MAP coordination. In some embodiments, the processor 340 includes at least one microprocessor or microcontroller.

The processor 340 is also capable of executing other processes and programs resident in the memory 360, such as operations for facilitating a framework for TDMA based MAP coordination. The processor 340 can move data into or out of the memory 360 as required by an executing process. In some embodiments, the processor 340 is configured to execute a plurality of applications 362, such as applications for facilitating a framework for TDMA based MAP coordination. The processor 340 can operate the plurality of applications 362 based on the OS program 361 or in response to a signal received from an AP. The processor 340 is also coupled to the I/O interface 345, which provides STA 111 with the ability to connect to other devices such as laptop computers and handheld computers. The I/O interface 345 is the communication path between these accessories and the processor 340.

The processor 340 is also coupled to the input 350, which includes for example, a touchscreen, keypad, etc., and the display 355. The operator of the STA 111 can use the input 350 to enter data into the STA 111. The display 355 may be a liquid crystal display, light emitting diode display, or other display capable of rendering text and/or at least limited graphics, such as from web sites. The memory 360 is coupled to the processor 340. Part of the memory 360 could include a random-access memory (RAM), and another part of the memory 360 could include a Flash memory or other read-only memory (ROM).

Although FIG. 3 illustrates one example of STA 111, various changes may be made to FIG. 3. For example, various components in FIG. 3 could be combined, further subdivided, or omitted and additional components could be added according to particular needs. In particular examples, the STA 111 may include any number of antenna(s) 305 for MIMO communication with an AP 101. In another example, the STA 111 may not include voice communication or the processor 340 could be divided into multiple processors, such as one or more central processing units (CPUs) and one or more graphics processing units (GPUs). Also, while FIG. 3 illustrates the STA 111 configured as a mobile telephone or smartphone, STAs could be configured to operate as other types of mobile or stationary devices.

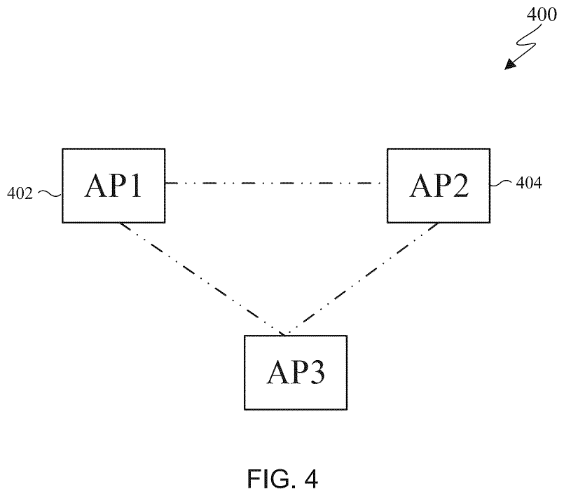

Embodiments of the present disclosure recognize that MAP coordination is considered as one of the key technologies for the next generation WLAN systems. In MAP coordination, several neighboring APs coordinate with each other for improved network performance. This is illustrated in FIG. 4, which illustrates an example 400 of MAP coordination according to embodiments of the present disclosure. The example 400 can be performed by gNBs 101-103 in the wireless network 100 of FIG. 1. The embodiment of the example 400 of MAP coordination shown in FIG. 4 is for illustration only. Other embodiments of the example 400 of MAP coordination could be used without departing from the scope of this disclosure.

Embodiments of the present disclosure recognize that interference from one basic service set (BSS) often causes performance issues for stations (STAs) and APs in nearby BSSs. This naturally results in overall throughput degradation in the network. The overlapping BSS (OBSS) interference can also increase the overall latency since it takes more time for accessing the channel due the interference occupying the channel. If a STA in a BSS has latency-sensitive traffic, this delay in channel access can seriously hamper the STA's latency-sensitive applications. Embodiments of the present disclosure further recognize that currently, there is no generalized framework for time division based multi-AP coordination. Such framework would be needed for next generation WLAN systems.

Accordingly, various embodiments of the present disclosure can provide methods and apparatuses for a coordinated TDMA (C-TDMA) framework. Further, various embodiments of the present disclosure can provide methods and apparatuses for a transmit opportunity (TXOP) sharing framework between multiple APs. Further still, various embodiments of the present disclosure can provide methods and apparatuses for a single trigger frame for TXOP allocation to multiple APs.

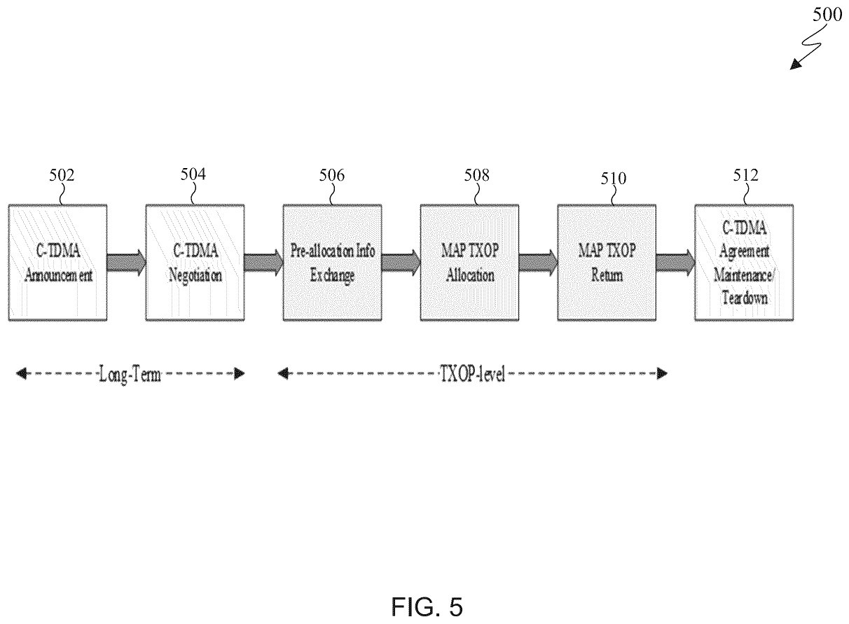

FIG. 5 illustrates an example of an overall framework 500 for coordinated TDMA (C-TDMA) according to embodiments of the present disclosure. The embodiment of the overall framework 500 for C-TDMA shown in FIG. 5 is for illustration only. Other embodiments of the overall framework 500 for C-TDMA could be used without departing from the scope of this disclosure.

According to some embodiments, a first AP can coordinate with a second AP in the vicinity in order to coordinate with the first AP on the basis of TDMA. The coordination mechanism can take different formats based on the architecture of the coordinated TDMA (C-TDMA) mechanism.

C-TDMA and any other multi-AP coordination should accommodate both the enterprise and non-enterprise (e.g. residential use cases) deployment scenarios.
The framework should be general enough that two APs from different vendors can also participate in multi-AP coordination and benefit from it.

Accordingly, for the C-TDMA, procedures for discovery and negotiation need to be integrated into the overall framework.
This would enable setting up the terms for coordination among the participating APs.

As illustrated in FIG. 5, the overall C-TDMA framework process may begin with a C-TDMA announcement 502. According to some embodiments, during this phase, the C-TDMA initiating AP can identify the other APs that are willing to participate in coordinated TDMA. During this phase, basic capability and coordination information can be announced by the initiating AP. If a neighboring AP is willing and prepared to participate in the C-TDMA coordination, it can inform the C-TDMA initiating AP by responding to the announcement received from the TWT sharing AP. This phase essentially forms a C-TDMA coordination group.

At step 504, a process of C-TDMA negotiation may occur. According to some embodiments, during this phase, C-TDMA parameters for MAP coordination may be decided among the participating APs. In some embodiments, the C-TDMA initiating AP can send a coordination request to the other APs in the C-TDMA coordination group. The request may contain the set of parameters that the initiating AP intends to use for coordination. Upon receiving the request, the responding AP can either accept/reject the request or suggest an alternative set of C-TDMA parameters. Upon successful negotiation, a long-term C-TDMA agreement may be set up among the participating APs.

According to some embodiments, during the C-TDMA negotiation phase, the participating APs may indicate their resource need as part of the multi-AP coordination with C-TDMA. This would set the long-term expectation on how often the TXOP sharing AP would need to trigger the participating shared APs and allocate the TXOPs. In some embodiments, stream classification service/quality of service (SCS/QoS) characteristics elements can be exchanged among the coordinating APs to indicate C-TDMA resource needs.

At step 506, there may be a pre-allocation information exchange between the participating APs for allocation of resources, such as transmit opportunity (TXOP). At steps 508 and 510, a MAP TXOP allocation and MAP TXOP return may occur to allocate the shared TXOP resource.

According to some embodiments, the TXOP requirements for the APs participating in the C-TDMA may fluctuate around the expected requirements that are set during the C-TDMA negotiation phase. As such, a mechanism for the APs to indicate to the TXOP sharing AP the updated C-TDMA resource requirements so that the TXOP sharing AP can appropriately allocate the TXOP may be provided. Alternatively, the TXOP sharing AP, before allocating the TXOP, may solicit such information from the other coordinating APs.

Sharing the buffer status report (BSR) serves a similar purposes for non-AP STAs receiving the TXOP from the associated AP. However, for C-TDMA, the TXOP received by the coordinating APs may also account for the portion of the time needed for triggering the non-AP STAs for uplink or P2P in the respective BSS.

In 802.11be, the TXOP sharing process using the MU-RTS TXS trigger frame allows only one STAs to be triggered at a time for TXOP allocation. This incurs recurrent overhead when the TXOP holder intends to allocate TXOPs to multiple STAs. In 802.11bn, for efficient operation, according to some embodiments, the group can consider to allocate TXOP to multiple STA or multiple APs using a single trigger frame. The current MU-RTS TXS trigger frame already has the necessary format to allow such multi-STA/multi-AP allocation.

In some embodiments, TXOP recipient identifiers can be listed in the user info field. For 802.11bn, the spec change can be as simple as lifting the current restriction of “single user-only” TXOP allocation using the TXS frame.

In some embodiments, an existing C-TDMA agreement between two coordinating APs may not be perpetual in nature. In that case, there may be a need to modify an existing agreement. Such modification is desirable when the load condition changes in one of the participating AP's BSS. For example, when the load increases, more TXOP allocation would be desirable.

According to some embodiments, modification of an existing agreement can be characterized by replacing the previous set of C-TDMA parameters with a new set of C-TDMA parameters. According to some embodiments, a time instant can be indicated when the new C-TDMA parameter sets can take effect. Similarly, as illustrated at step 512, there may be a need for a mechanism to tear down or opt out of an existing C-TDMA agreement.

As described above with reference to FIG. 4, the first AP 402 can coordinate with the second AP 404 in the vicinity in order to coordinate with the first AP 402 on the basis of MAP coordination. The coordination mechanism can take different formats based on the architecture of the MAP coordination mechanism.

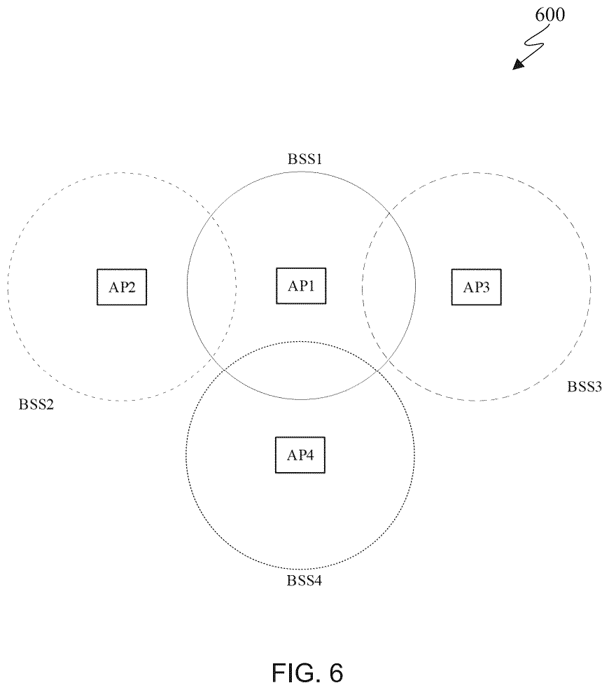

FIG. 6 illustrates an example 600 of an architecture for MAP negotiation according to embodiments of the present disclosure. The embodiment of the example 600 of an architecture for MAP negotiation shown in FIG. 6 is for illustration only. Other embodiments of the example 600 of an architecture for MAP negotiation could be used without departing from the scope of this disclosure.

In the Type-I architecture of MAP coordination, the APs participating in the multi-AP coordination can directly exchange frames within themselves to negotiate on the multi-AP TDMA coordination. A Type-I architecture for MAP coordination negotiation is illustrated in FIG. 6.

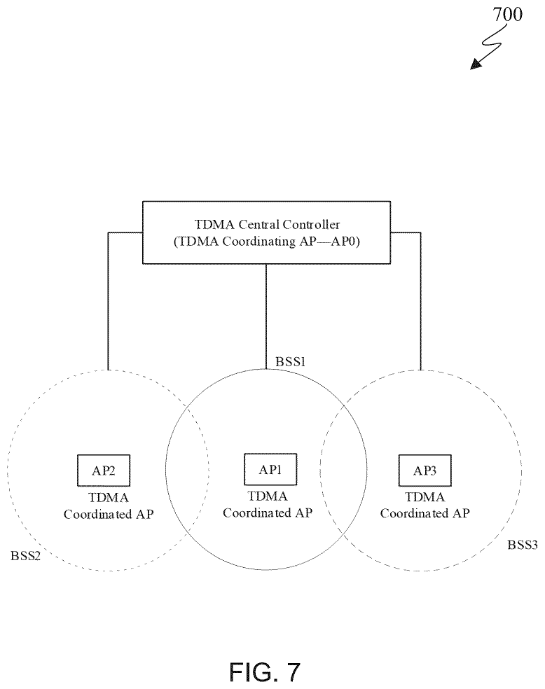

FIG. 7 illustrates another example 700 of an architecture for MAP negotiation according to embodiments of the present disclosure. The embodiment of the example 700 of an architecture for MAP negotiation shown in FIG. 7 is for illustration only. Other embodiments of the example 700 of an architecture for MAP negotiation could be used without departing from the scope of this disclosure.

In Type-II architecture of MAP coordination negotiation, the APs' (for example C-TDMA scheduling APs) MAP negotiations are controlled by a C-TDMA central controller. Any kind of MAP coordination negotiation is done through the central controller. A Type-II architecture for MAP coordination negotiation is illustrated in FIG. 7.

Embodiments of the present disclosure further recognize that there can be more than one MAP coordination between a first AP and a second AP. However, currently, there is no mechanism to identify each of the multiple of MAP coordination a first AP can have with a second AP

Accordingly, various embodiments of the present disclosure can provide methods and apparatuses for MAP agreement identification for MAP coordination between a first AP and a second AP.

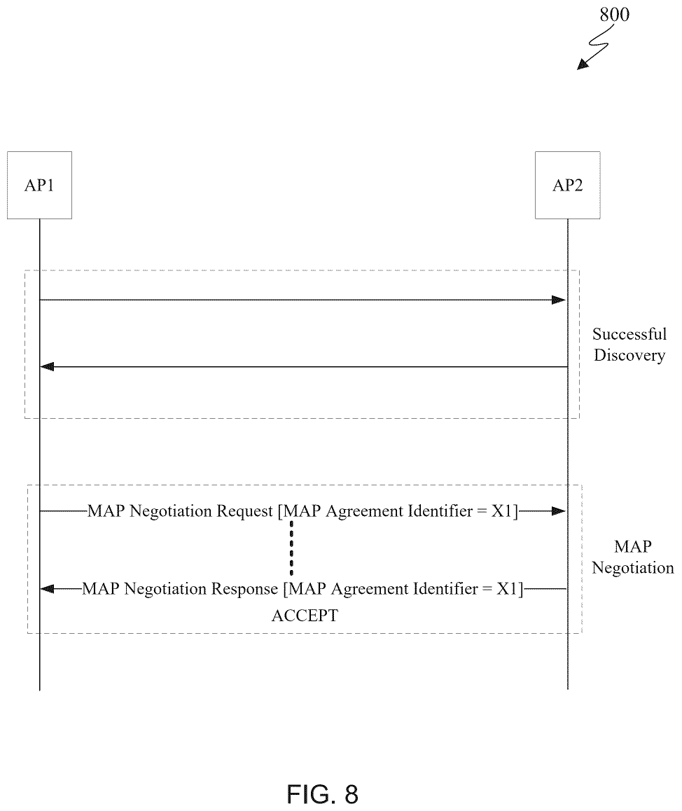

FIG. 8 illustrates an example 800 of AP agreement ID assignment according to embodiments of the present disclosure. The embodiment of the example 800 of AP agreement ID assignment shown in FIG. 8 is for illustration only. Other embodiments of the example 800 of AP agreement ID assignment could be used without departing from the scope of this disclosure.

According to some embodiments, for the scenario where a first AP intends to coordinate with a second AP and sends an individually addressed (management) message or frame to the second AP indicating a request for parameter negotiation for the parameters of the intended MAP coordination mechanism (e.g., coordinated restricted target wake time (C-RTWT), C-TDMA, coordinated beamforming (C-BF), etc.), the request frame may contain an agreement identifier information for each of the type of successful MAP coordination. For this purpose, the first AP can include a MAP agreement identifier field in the MAP negotiation request frame. The MAP agreement identifier field can contain the identifier of a particular MAP agreement that is currently under negotiation between the first AP and the second AP.

According to some embodiments, the MAP agreement identifier can be either 2 bits or 3 bits or 4 bits or 5 bits or 6 bits long.

According to some embodiments, for the scenario where a first AP intends to coordinate with a second AP and sends an individually addressed (management) message or frame to the second AP indicating a request for parameter negotiation for the parameters of the intended MAP coordination mechanism (e.g., C-RTWT, C-TDMA, C-BF, etc.), if the first AP includes a MAP agreement identifier, then upon receiving the request frame, the second AP can send a response frame to the first AP that also contain the same MAP agreement identifier that the first AP had included in the request frame. According to another embodiment, the second AP may include a MAP agreement identifier if the first AP intends to accept the MAP coordination request from the second AP. This is illustrated in FIG. 8.

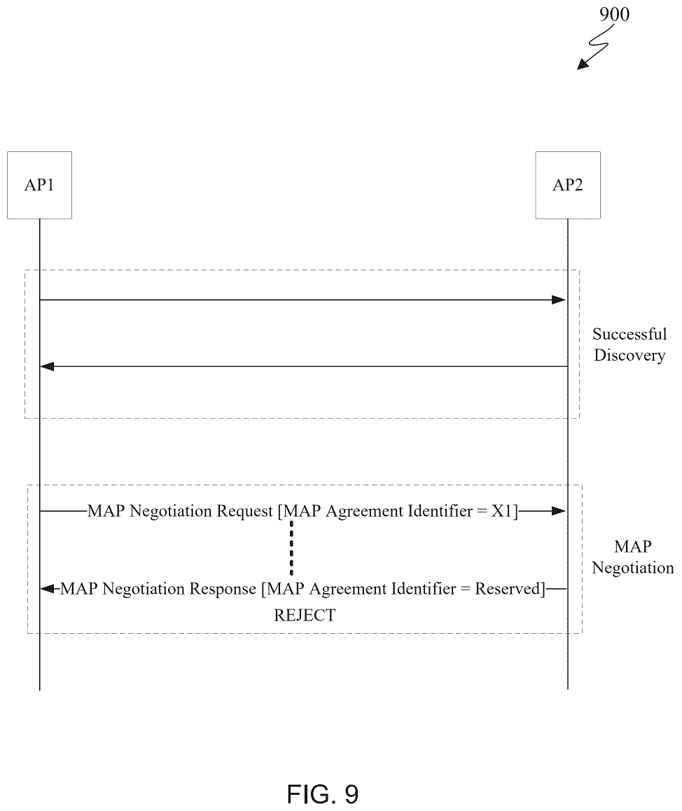

FIG. 9 illustrates another example 900 of AP agreement ID assignment according to embodiments of the present disclosure. The embodiment of the example 900 of AP agreement ID assignment shown in FIG. 9 is for illustration only. Other embodiments of the example 900 of AP agreement ID assignment could be used without departing from the scope of this disclosure.

In reference to the previous embodiment, according to one embodiment, upon receiving the request from the first AP, if the second AP intends to reject the request, then in the response frame, the second AP may not include the MAP agreement identifier field. According to another embodiment, upon receiving the request from the first AP, if the second AP intends to reject the request, then in the response frame, the second AP may still include the MAP Agreement Identifier field. According to yet another embodiment, in such a case, the MAP agreement identifier field in the response frame can be reserved or can be omitted by the first AP. This is illustrated in FIG. 9.

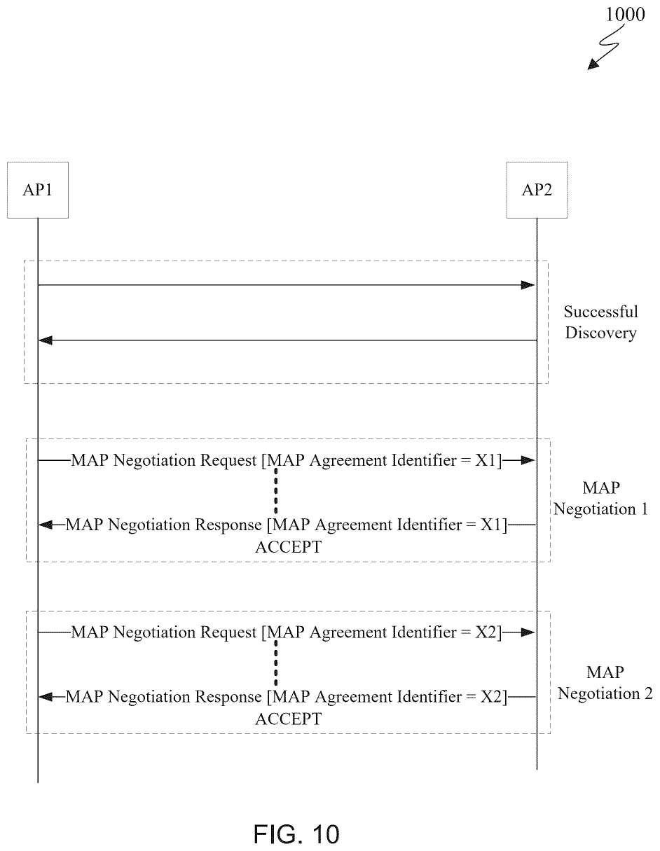

FIG. 10 illustrates yet another example 1000 of AP agreement ID assignment according to embodiments of the present disclosure. The embodiment of the example 1000 of AP agreement ID assignment shown in FIG. 10 is for illustration only. Other embodiments of the example 1000 of AP agreement ID assignment could be used without departing from the scope of this disclosure.

According to some embodiments, for the scenario where a first AP intends to coordinate with a second AP and sends an individually addressed (management) message or frame to the second AP indicating a request for parameter negotiation for the parameters of the intended MAP coordination mechanism (e.g., C-RTWT, C-TDMA, C-BF, etc.), if the first AP includes a MAP agreement identifier, the upon receiving the request frame, the second AP can send a response frame to the first AP that also contain the same MAP agreement identifier that the first AP had included in the request frame.

According to some embodiments, for the scenario where a first AP intends to coordinate with a second AP and sends an individually addressed (management) message or frame to the second AP indicating a request for parameter negotiation for the parameters of the intended MAP coordination mechanism (e.g., C-RTWT, C-TDMA, C-BF, etc.), where the first AP includes a MAP agreement identifier, if the second AP includes a MAP agreement identifier field in the response frame, then value of the agreement identifier field in the response frame sent by the second AP can be different from the value in the agreement identifier field in the request frame sent by the first AP. If the values are different, then it may be interpreted such that the second AP prefers to not use the value suggested by the first frame in the request frame, and instead prefers to use the value suggested by the second AP in the response frame.

According to some embodiments, between a first AP and a second AP, each successful multi-AP coordination agreement may have a unique MAP agreement identifier. For example, the first AP and the second AP can first have a coordinated TDMA agreement, which can be identified by a MAP agreement identifier value=1; later on the first AP and the second AP can have a coordinated RTWT agreement, which can be identified by a MAP agreement identifier value=2. This is illustrated in FIG. 10.

According to some embodiments, between a first AP and a second AP, if there are multiple agreements of the same multiple coordination type (e.g., C-TDMA), then each of those agreements can have a unique MAP agreement identifier. For example, the first AP and the second AP can first have a first coordinated TDMA agreement, which can be identified by a MAP agreement identifier value=1; later on the first AP and the second AP can have a second coordinated TDMA agreement, which can be identified by a MAP agreement identifier value=2.

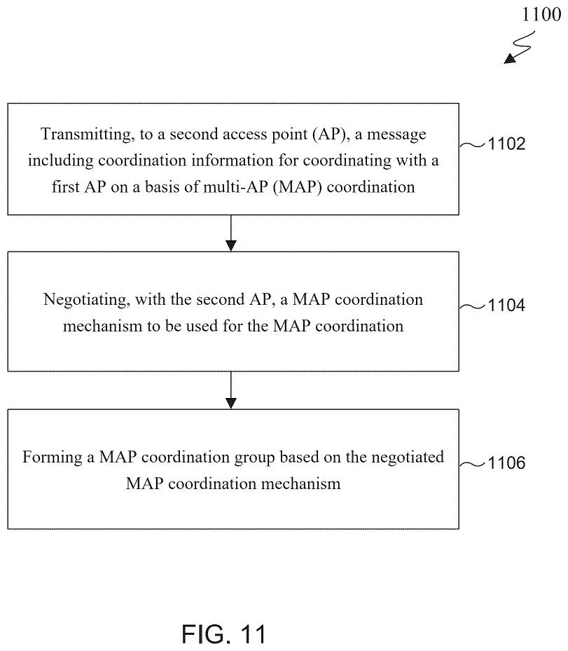

FIG. 11 illustrates an example method 1100 performed by a first AP in a wireless communication system according to embodiments of the present disclosure. The method 1100 of FIG. 11 can be performed by any of the APs 102-103 of FIG. 1, such as the AP 102 of FIG. 2. The method 1100 is for illustration only and other embodiments can be used without departing from the scope of the present disclosure.

As illustrated in FIG. 11, the method 1100 begins at step 1102, where the first AP transmits, to a second AP, a message including coordination information for coordinating with the first AP on a basis of multi-AP (MAP) coordination. At step 1104, the first AP negotiates, with the second AP, a MAP coordination mechanism to be used for the MAP coordination. At step 1106, the first AP forms a MAP coordination group based on the negotiated MAP coordination mechanism.

In some embodiments, the MAP coordination mechanism comprises coordinated time division multiple access (C-TDMA); and to negotiate the MAP coordination mechanism to be used for the MAP coordination, the first AP transmits, to the second AP, a coordination request including C-TDMA parameters that the first AP intends to use for the MAP coordination; and receives a response to the coordination request from the second AP that either accepts the C-TDMA parameters, rejects the C-TDMA parameters, or suggests an alternate set of C-TDMA parameters for the MAP coordination.

In some embodiments, to negotiate the MAP coordination mechanism to be used for the MAP coordination, the first AP negotiates sharing of a transmit opportunity (TXOP) with the second AP; receives C-TDMA resource requirements of the second APs; and allocates the TXOP to the second AP based on the TXOP sharing negotiation.

In some embodiments, the first AP receives an indication from the second AP associated with updated C-TDMA resource requirements of the second AP; and allocates the TXOP to the second AP based on the updated C-TDMA resource requirements of the second AP and the TXOP sharing negotiation.

In some embodiments, to negotiate the MAP coordination mechanism to be used for the MAP coordination, the first AP negotiates sharing of a transmit opportunity (TXOP) with the second AP; and allocates the TXOP to the second AP based on the TXOP sharing negotiation using a single trigger message.

In some embodiments, the MAP coordination mechanism comprises one or more MAP coordination mechanisms; and to negotiate the MAP coordination mechanism to be used for the MAP coordination, the first AP transmits an individually addressed message to the second AP indicating a request for parameter negotiation for parameters of an intended MAP coordination mechanism of the one or more MAP coordination mechanisms, wherein the individually addressed message includes agreement identifier information associated with a successful MAP coordination agreement.

In some embodiments, the agreement identifier information includes an identifier of a MAP coordination agreement that is currently under negotiation between the first AP and the second AP.

In some embodiments, the first AP receives a response message from the second AP that indicates whether the second AP accepts the identifier, rejects the identifier, or suggests an alternate identifier of the MAP coordination agreement.

In some embodiments, the agreement identifier information includes an identifier of a particular MAP coordination agreement; and each successful MAP coordination agreement has a unique agreement identifier.

In some embodiments, each of multiple successful MAP coordination agreements of a same MAP coordination mechanism has a unique agreement identifier.

The flowcharts herein illustrate example methods or processes that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method of wireless communication performed by a first access point (AP), the method comprising:
transmitting, to a second AP, a message including coordination information for coordinating with the first AP on a basis of multi-AP (MAP) coordination;
negotiating, with the second AP, a MAP coordination mechanism to be used for the MAP coordination; and
forming a MAP coordination group based on the negotiated MAP coordination mechanism.

2. The method of claim 1, wherein:
the MAP coordination mechanism comprises coordinated time division multiple access (C-TDMA); and
negotiating the MAP coordination mechanism to be used for the MAP coordination comprises:
transmitting, to the second AP, a coordination request including C-TDMA parameters that the first AP intends to use for the MAP coordination; and
receiving a response to the coordination request from the second AP that either accepts the C-TDMA parameters, rejects the C-TDMA parameters, or suggests an alternate set of C-TDMA parameters for the MAP coordination.

3. The method of claim 2, wherein negotiating the MAP coordination mechanism to be used for the MAP coordination further comprises:
negotiating sharing of a transmit opportunity (TXOP) with the second AP;
receiving C-TDMA resource requirements of the second APs; and
allocating the TXOP to the second AP based on the TXOP sharing negotiation.

4. The method of claim 3, further comprising:
receiving an indication from the second AP associated with updated C-TDMA resource requirements of the second AP; and
allocating the TXOP to the second AP based on the updated C-TDMA resource requirements of the second AP and the TXOP sharing negotiation.

5. The method of claim 2, wherein negotiating the MAP coordination mechanism to be used for the MAP coordination further comprises:
negotiating sharing of a transmit opportunity (TXOP) with the second AP; and
allocating the TXOP to the second AP based on the TXOP sharing negotiation using a single trigger message.

6. The method of claim 1, wherein:
the MAP coordination mechanism comprises one or more MAP coordination mechanisms; and
negotiating the MAP coordination mechanism to be used for the MAP coordination comprises:
transmitting an individually addressed message to the second AP indicating a request for parameter negotiation for parameters of an intended MAP coordination mechanism of the one or more MAP coordination mechanisms, wherein the individually addressed message includes agreement identifier information associated with a successful MAP coordination agreement.

7. The method of claim 6, wherein the agreement identifier information includes an identifier of a MAP coordination agreement that is currently under negotiation between the first AP and the second AP.

8. The method of claim 7, further comprising receiving a response message from the second AP that indicates whether the second AP accepts the identifier, rejects the identifier, or suggests an alternate identifier of the MAP coordination agreement.

9. The method of claim 6, wherein:
the agreement identifier information includes an identifier of a particular MAP coordination agreement; and
each successful MAP coordination agreement has a unique agreement identifier.

10. The method of claim 6, wherein each of multiple successful MAP coordination agreements of a same MAP coordination mechanism has a unique agreement identifier.

11. A first access point (AP) comprising:
a transceiver configured to transmit, to a second AP, a message including coordination information for coordinating with the first AP on a basis of multi-AP (MAP) coordination; and
a processor operably coupled with the transceiver, the processor configured to:
negotiate, with the second AP, a MAP coordination mechanism to be used for the MAP coordination; and
form a MAP coordination group based on the negotiated MAP coordination mechanism.

12. The first AP of claim 11, wherein:
the MAP coordination mechanism comprises coordinated time division multiple access (C-TDMA); and
to negotiate the MAP coordination mechanism to be used for the MAP coordination, the processor is further configured to:
transmit, via the transceiver to the second AP, a coordination request including C-TDMA parameters that the first AP intends to use for the MAP coordination; and
receive, via the transceiver, a response to the coordination request from the second AP that either accepts the C-TDMA parameters, rejects the C-TDMA parameters, or suggests an alternate set of C-TDMA parameters for the MAP coordination.

13. The first AP of claim 12, wherein to negotiate the MAP coordination mechanism to be used for the MAP coordination, the processor is further configured to:
negotiate sharing of a transmit opportunity (TXOP) with the second AP;
receive, via the transceiver, C-TDMA resource requirements of the second APs; and
allocate the TXOP to the second AP based on the TXOP sharing negotiation.

14. The first AP of claim 13, wherein the processor is further configured to:
receive, via the transceiver, an indication from the second AP associated with updated C-TDMA resource requirements of the second AP; and
allocate the TXOP to the second AP based on the updated C-TDMA resource requirements of the second AP and the TXOP sharing negotiation.

15. The first AP of claim 12, wherein to negotiate the MAP coordination mechanism to be used for the MAP coordination, the processor is further configured to:
negotiate sharing of a transmit opportunity (TXOP) with the second AP; and
allocate the TXOP to the second AP based on the TXOP sharing negotiation using a single trigger message.

16. The first AP of claim 11, wherein:
the MAP coordination mechanism comprises one or more MAP coordination mechanisms; and
to negotiate the MAP coordination mechanism to be used for the MAP coordination, the processor is further configured to:
transmit, via the transceiver, an individually addressed message to the second AP indicating a request for parameter negotiation for parameters of an intended MAP coordination mechanism of the one or more MAP coordination mechanisms, wherein the individually addressed message includes agreement identifier information associated with a successful MAP coordination agreement.

17. The first AP of claim 16, wherein the agreement identifier information includes an identifier of a MAP coordination agreement that is currently under negotiation between the first AP and the second AP.

18. The first AP of claim 17, where the transceiver is further configured to receive a response message from the second AP that indicates whether the second AP accepts the identifier, rejects the identifier, or suggests an alternate identifier of the MAP coordination agreement.

19. The first AP of claim 16, wherein:
the agreement identifier information includes an identifier of a particular MAP coordination agreement; and
each successful MAP coordination agreement has a unique agreement identifier.

20. The first AP of claim 16, wherein each of multiple successful MAP coordination agreements of a same MAP coordination mechanism has a unique agreement identifier.
